(19) United States
(12) Patent Application Publication
(10) Pub. No.: US 2023/0299369 A1
(43) Pub. Date: Sep. 21, 2023

(54) TEMPERATURE BASED BATTERY CONTROL

(71) Applicant: FORD GLOBAL TECHNOLOGIES, LLC, Dearborn, MI (US)

(72) Inventors: Monty J. ANDERSON, Boise, ID (US); William Robert BROWN, Huntington Woods, MI (US); Zachary MARCH, Highlands Ranch, CO (US); Justin BARSANO, Hazel Park, MI (US); Elaine Y. CHEN, Dearborn, MI (US)

(21) Appl. No.: 17/671,089

(22) Filed: Feb. 14, 2022

(51) Int. Cl. H01M 10/44; B60L 58/25; B60L 3/00; B60L 58/16

(52) U.S. Cl. CPC H01M 10/443; B60L 3/0046; B60L 58/16; B60L 58/25; B60L 2240/545

(57) ABSTRACT

Responsive to data indicative of a temperature of a contactor connecting a battery and motor exceeding a threshold, a controller decreases power output from the battery to the motor. The data include parameters indicative of a temperature of the battery, a resistance of an electrical component between the battery and motor, and a thermal resistivity of one or more components other than the battery and motor in a vicinity of the contactor.

### TECHNICAL FIELD

The present disclosure relates to measuring/estimating a contactor temperature of an electric vehicle battery.

### BACKGROUND

Electric vehicles rely on one or more high-voltage (HV) batteries to provide electric power for propulsion. One or more main contactors may be positioned between the HV batteries and an electric motor of the vehicle to enable connection and disconnection.

### SUMMARY

A vehicle includes a battery, a motor, a contactor contained in a housing and connected between the battery and motor, and a controller. The controller, responsive to data indicative of a temperature of the contactor exceeding a threshold, decreases power output from the battery to the motor. The data include parameters indicative of a temperature of the battery, a resistance of an electrical component between the battery and motor, and a thermal resistivity of one or more components other than the battery and motor in a vicinity of the contactor.

A power system includes a controller that executes instructions implementing a thermal model that produces output indicative of a temperature of a contactor connecting a battery and motor based on input indicative of a thermal resistivity of one or more components other than the battery and motor in a vicinity of the contactor, and decreases power output from the battery to the motor responsive to the temperature exceeding a threshold.

A method includes decreasing power output from a battery to a motor after data indicates a temperature of a contactor electrically connecting the battery and motor exceeds a threshold. The data include parameters indicative of a temperature of the battery, a resistance of an electrical component between the battery and motor, and a thermal resistivity of a housing of the contactor.

### BRIEF DESCRIPTION OF THE DRAWINGS

FIG. 1 illustrates an example block topology of an electrified vehicle illustrating drivetrain and energy storage components.

FIG. 2 illustrates an example block diagram of a main contactor second order thermal model.

FIG. 3 illustrates an example flow diagram for a battery power mitigation process based on the main contactor temperature.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure proposes a method and system for measuring/estimating a contactor temperature of an electric vehicle battery.

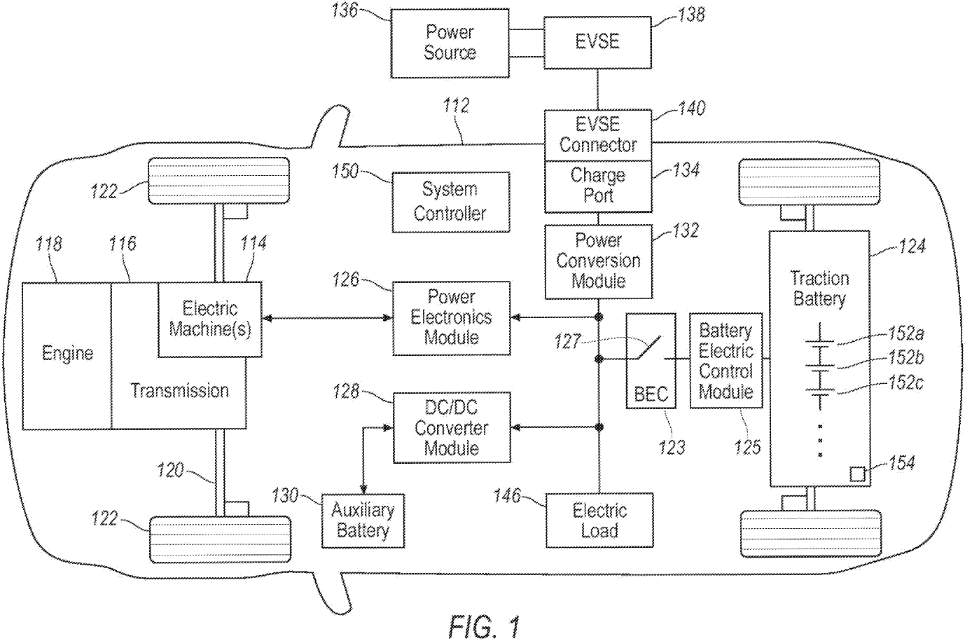

FIG. 1 illustrates a plug-in hybrid-electric vehicle (PHEV). A plug-in hybrid-electric vehicle 112 may include one or more electric machines (electric motors) 114 mechanically coupled to a hybrid transmission 116. The electric machines 114 may be capable of operating as a motor or a generator. In addition, the hybrid transmission 116 is mechanically coupled to an engine 118. The hybrid transmission 116 is also mechanically coupled to a drive shaft 120 that is mechanically coupled to the wheels 122. The electric machines 114 may provide propulsion and slowing capability when the engine 118 is turned on or off. The electric machines 114 may also act as generators and may provide fuel economy benefits by recovering energy that would be lost as heat in the friction braking system. The electric machines 114 may also reduce vehicle emissions by allowing the engine 118 to operate at more efficient speeds and allowing the hybrid-electric vehicle 112 to be operated in electric mode with the engine 118 off under certain conditions.

A traction battery or battery pack 124 stores energy that may be used by the electric machines 114. A vehicle battery pack 124 may provide a high voltage DC output. The traction battery 124 may be electrically coupled to one or more battery electric control modules (BECM) 125. The BECM 125 is also known as the battery management system (BMS) 125. The BECM 125 may be provided with one or more processors and software applications configured to monitor and control various operations of the traction battery 124. The traction battery 124 may be further electrically coupled to one or more power electronics modules 126. The power electronics module 126 may also be referred to as a power inverter. A bussed electrical center (BEC) 123 may be provided between the traction battery 124 and the power electronics modules 126 and configured to connect and isolate the battery 124 from the rest of the vehicle 112. The BEC 123 may include one or more main contactors 127 configured isolate the traction battery 124 and the BECM 125 from other components when opened and couple the traction battery 124 and the BECM 125 to other components when closed. The BEC 123 may further include protective components such as fuses (not shown) configured to disable the BEC responsive to an excessive current or temperature on the main contactors 127. The power electronics module 126 may also be electrically coupled to the electric machines 114 and provide the ability to bi-directionally transfer energy between the traction battery 124 and the electric machines 114. For example, a traction battery 124 may provide a DC voltage while the electric machines 114 may operate using a three-phase AC current. The power electronics module 126 may convert the DC voltage to a three-phase AC current for use by the electric machines 114. In a regenerative mode, the power electronics module 126 may convert the three-phase AC current from the electric machines 114 acting as generators to the DC voltage compatible with the traction battery 124. The description herein is equally applicable to a pure electric vehicle. For a pure electric vehicle, the hybrid transmission 116 may be a gear box connected to the electric machine 114 and the engine 118 may not be present.

In addition to providing energy for propulsion, the traction battery 124 may provide energy for other vehicle electrical systems. A vehicle may include a DC/DC converter module 128 that converts the high voltage DC output of the traction battery 124 to a low voltage DC supply that is compatible with other low-voltage vehicle loads. An output of the DC/DC converter module 128 may be electrically coupled to an auxiliary battery 130 (e.g., 12V battery).

The vehicle 112 may be a battery electric vehicle (BEV) or a plug-in hybrid electric vehicle (PHEV) in which the traction battery 124 may be recharged by an external power source 136. The external power source 136 may be a connection to an electrical outlet. The external power source 136 may be an electrical power distribution network or grid as provided by an electric utility company. The external power source 136 may be electrically coupled to electric vehicle supply equipment (EVSE) 138. The EVSE 138 may provide circuitry and controls to manage the transfer of energy between the power source 136 and the vehicle 112. The external power source 136 may provide DC or AC electric power to the EVSE 138. The EVSE 138 may have a charge connector 140 for plugging into a charge port 134 of the vehicle 112. The charge port 134 may be any type of port configured to transfer power from the EVSE 138 to the vehicle 112. The charge port 134 may be electrically coupled to a charger or on-board power conversion module 132. The power conversion module 132 may condition the power supplied from the EVSE 138 to provide the proper voltage and current levels to the traction battery 124. The power conversion module 132 may interface with the EVSE 138 to coordinate the delivery of power to the vehicle 112. The EVSE connector 140 may have pins that mate with corresponding recesses of the charge port 134. Alternatively, various components described as being electrically coupled may transfer power using a wireless inductive coupling.

One or more electrical loads 146 may be coupled to the high-voltage bus. The electrical loads 146 may have an associated controller that operates and controls the electrical loads 146 when appropriate. Examples of electrical loads 146 may be a heating module, an air-conditioning module, or the like.

The various components discussed may have one or more associated controllers to control and monitor the operation of the components. The controllers may communicate via a serial bus (e.g., Controller Area Network (CAN)) or via discrete conductors. A system controller 150 may be present to coordinate the operation of the various components. For instance, the system controller 150 may include a powertrain control module (PCM) configured to operate the powertrain of the vehicle 112. It is noted that the system controller 150 is used as a general term and may include one or more controller devices configured to perform various operations in the present disclosure. For instance, the system controller 150 may be programmed to enable a powertrain control function to operate the powertrain of the vehicle 112. The system controller 150 may be further programmed to enable a telecommunication function with various entities (e.g. a server) via a wireless network (e.g. a cellular network).

The system controller 150 and/or BECM 125, individually or combined, may be programmed to perform various operations with regard to the traction battery 124 and the BEC 123. For instance, the system controller 150 and/or BECM 125 may be configured to measure and estimate the temperature of the main contactor 127 based on various factors such as the battery temperature. The traction battery 124 may include a plurality of battery cells 152 connected in series. The temperature of cells 152 may be measured via one or more temperature sensors 154. The temperature sensor 154 may be implemented in various manners. For instance, the temperature sensors 154 may include one or more thermistors configured to measure the temperature of the battery cells 152 using the resistance of a resistor.

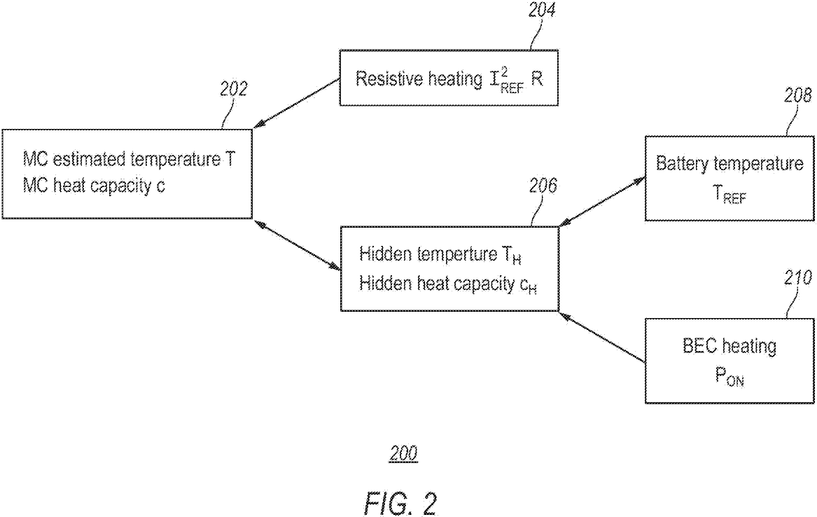

Referring to FIG. 2, an example block diagram of a main contactor second order thermal model 200 is illustrated. With continuing reference to FIG. 1, the thermal characteristics of the main contactor 127 may be represented by various factors. As illustrated with reference to box 202, the thermal characteristics 202 of the main contactor 127 may include a main contactor temperature T. The thermal characteristics 202 may further include a main contactor heat capacity c indicative of the amount of heat to be supplied to the main contactor 127 to produce a unit change in the temperature T. The heat capacity c may be represented by units of joules per kelvin (J/K) or joule per degree Celsius (J/°C). The heat capacity c of the main contactor 127 may be known to the vehicle system under the current thermal model 200. The main contactor temperature T may be affected by various factors depending on the operation condition of the vehicle 112. For instance, the main contactor temperature T may be affected by the resistive heating represented by I²_{REF}R (i.e. the first order modelling), wherein I_{REF} denotes the current flowing through the main contactor 127 and R denotes the electrical resistance of the main contactor 127. Under the present thermal model, the main contactor temperature T may further associate with hidden characteristics 206 between the main contactor 127 and the battery 124 (i.e. the second order modelling). The hidden characteristics 206 may include a hidden temperature T_{H} indicative of a temperature of intermediate thermal mass between main contactor 127 and the battery 124, and a hidden heat capacity c_{H} indicative of the heat capacity corresponding to the hidden temperature T_{H}. For instance, the hidden characteristics 206 may represent a thermal profile caused by the housing/shell of the BEC 123 containing the main contactor 127 and trapping the heat inside. Although ventilation may be provided to the BEC 123, a part of the heat may still be trapped inside constituting the hidden thermal characteristics 206. The hidden characteristics 206 may be affected by two main factors: the battery temperature T_{REF} 208 and the BEC heating Pₒₙ 210. The battery temperature T_{REF} may be indicative of a temperature of the battery 124 used as a reference in the present thermal model 200. In one example, the battery temperature T_{REF} may be directly measured by the one or more temperature sensors 154. Alternatively, the battery temperature T_{REF} may be a derived/estimated value. Due to the proximity from the traction battery 124, heat generated by the traction battery 124 during the operation of the vehicle 112 may be transferred to the main contactor 127 in a proportion represented by (T_{REF} -T_{H})/R_{T2,} wherein R_{T2} denotes the thermal resistivity between a hardware location at which the temperature T_{H} is estimated and the traction battery 127 having the temperature T_{REF} in units of degrees per watt (°C/W). The BEC heating Pₒₙ 210 may represent heat generated by a constant source of BEC heating while the vehicle is on in units of watts. The hidden thermal characteristics 206 may transfer heat to the main contactor characteristics in a proportion represented by (T_{H} -T)/R_{T1}, wherein R_{T1} denotes the thermal resistivity between the main contactor 127 having the temperature of T and a hardware at which the temperature of T_{H} is estimated in units of degrees per watt.

The vehicle 112 may use the thermal model 200 illustrated with reference to FIG. 2 to estimate the temperature of the main contactor 127 and perform vehicle operation controls accordingly. The thermal model 200 may be governed by the following equations (1) and (2):

$$\dot{T} c = \left({T}_{H} - T\right) / {R}_{T 1} + {I}_{R E F}^{2} R \qquad \text{(1)}$$

$${\dot{T}}_{H} {c}_{H} = \left(T - {T}_{H}\right) / {R}_{T 1} + \left({T}_{R E F} - {T}_{H}\right) / {R}_{T 2} {P}_{o n} \qquad \text{(2)}$$

wherein Tc denotes the derivative of the main contactor temperature T with respect to time in units of degrees Celsius per second (°C/s), and T_{H} denotes the derivative of the hidden temperature T_{H} with respect to time in units of degrees Celsius per second. The main contactor temperature T and the hidden temperature T_{H} may be calculated using the following equations (3) and (4):

$$T \left({t}_{j}\right) = T \left({t}_{j - 1}\right) {C}_{T D} + g \left(1 - {C}_{T D}\right) \qquad \text{(3)}$$

$${T}_{H} \left({t}_{j}\right) = {T}_{H} \left({t}_{j - 1}\right) {C}_{T D \text{} \_ \text{} H} + {g}_{H} \left(1 - {C}_{T D \text{} \_ \text{} H}\right) \qquad \text{(4)}$$

In the above equations, tⱼ denotes the time at a present calculation and tⱼ₋₁ denotes the time at a previous calculation; g denotes a target temperature of the main contactor 127 in units of degrees Celsius (°C) as the main contactor temperature estimate will continuously decay towards this estimated value which is updated each iteration; g_{H} denotes a target hidden temperature in units of degrees Celsius as the hidden temperature estimate will continuously decay towards this estimated value which is updated each iteration; and C_{TD}, C_{TD_}_{H} denote coefficients of the thermal decay for the main contactor 127 and the hidden temperature respectively. At every calculation iteration (e.g. at time tⱼ) the temperature estimates T and T_{H} are updated by decaying from their respective previous estimations (e.g. at time tⱼ₋₁) to their respective temperature targets g and g_{H}. The target main contactor temperature g and the target hidden temperature g_{H} may be calculate using the equations (5) and (6) below:

$$g = {T}_{H} \left({t}_{j - 1}\right) + {I}_{R E F}^{2} \left({t}_{j}\right) R {R}_{T 1} \qquad \text{(5)}$$

$${g}_{H} = \frac{{T}_{R E F} \left({t}_{j - 1}\right) R {R}_{T 1} + T \left({t}_{j - 1}\right) R {R}_{T 2}}{R {R}_{T 1} \text{+} R {R}_{T 2}} + \text{Δ} {T}_{o n} \qquad \text{(6)}$$

wherein RR_{T1} denotes a bulk resistivity obtained by R*R_{T1}; RR_{T2} denotes a bulk resistivity obtained by R*R_{T2}. More specifically, R reflects the resistance of an electrical component (e.g. electrical cable) of the bulk resistivity. R_{T1} and R_{T2} reflect the thermal resistivity of one or more components (e.g. hardware, packaging, cooling system or the like) on the respective thermal communication paths. ΔTₒₙ denotes a hidden temperature offset when the vehicle is on calculated by the equation below:

$$\text{Δ} {T}_{o n} = {P}_{o n} \text{Δ} t / {C}_{H} \qquad \text{(7)}$$

The main contactor thermal decay coefficient C_{TD_}and the hidden temperature thermal decay coefficient C_{TD_}_{H} may be calculated by the formulae below:

$${C}_{T D} \sim e x p \left(- ∝ Δ t\right) \qquad \text{(8)}$$

$${C}_{T D \text{} \_ \text{} H} \sim e x p \left(- {∝}_{H} Δ t\right) \qquad \text{(9)}$$

wherein ∝ denotes the inverse time constant of the main contactor; ∝_{H} denotes the inverse time constant of the hidden temperature; and Δt denotes the discrete change in time between successive calculations Δt= Δtⱼ- Δtⱼ₋₁.

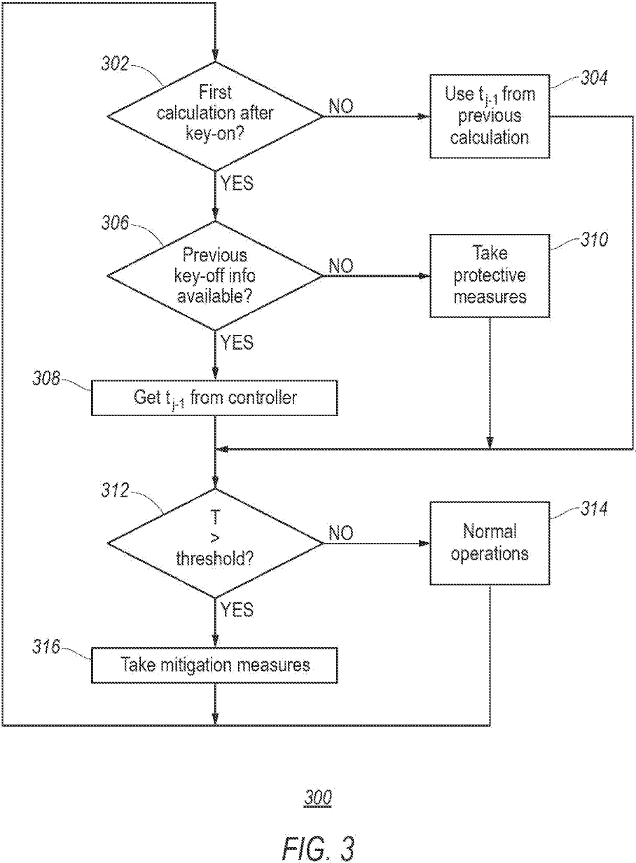

Referring to FIG. 3, an example flow diagram for a vehicle battery power mitigation process 300 based on the main contactor temperature is illustrated. With continuing reference to FIGS. 1 and 2, the process 300 may be individually or collectively implemented by the system controller 150 and/or the BECM 125. For simplicity purposes, the following description will be made with reference to the system controller 150. At operation 302, the system controller 150 verifies if the time tⱼ for the current cycle is the first calculation cycle after a vehicle key-on. In other words, the system controller 150 detects if a prior main contactor temperature estimation has already been performed after the last vehicle key-on event. If the answer is No, indicative of one or more temperature estimation being already performed, the process proceeds to operation 304 and the system controller 150 uses data obtained from the previous estimation tⱼ₋₁ for the current cycle processing. Otherwise, if the answer for operation 302 is Yes indicative of a first calculation cycle, the process proceeds to operation 306 and the system controller 150 verifies if the data from a previous key-off event is available (e.g. stored in a storage device when the vehicle is shut down). The system controller 150 may be configured to store those data in the storage responsive to a key-off event such that the parameters may be used for future reference when the vehicle is started the next time. If those data are available, the process proceeds to operation 308 and the system controller 150 loads the data from the last key-off as tⱼ₋₁ to perform the current cycle estimation. If the data from the last key-off is unavailable, indicative of an error state (e.g. due to a battery power disconnect when the vehicle is shut down), the process proceeds to operation 310 and the system controller 150 takes protective measures by decreasing the battery power output from the traction battery 124. In addition, the main contactor temperature for the current cycle may be calculated using the following equation:

$$T \left({t}_{j}\right) = min \left({T}_{m a x} , {T}_{R E F} \left({t}_{j}\right) + {T}_{o f f s e t}\right) \qquad \text{(10)}$$

wherein Tₘₐₓ denotes a maximum allowable temperature for the main contactor 127 without requiring any mitigation measures, and T_{offset} denotes a predefined offset temperature reflecting the correlation between the battery temperature T_{REF} and the main contactor temperature T. In an example, ΔTₒₙ described above may be used for T_{offset}.

At operation 312, the system controller 150 compares the estimated main contactor temperature T with a temperature threshold. As an example, the temperature threshold may be equal to the maximum allowable temperature Tₘₐₓ discussed above. Responsive to the main contactor temperature T as estimated being over the temperature threshold, the process proceeds to operation 316 and the system controller 150 takes mitigation measures by reducing the output power from the battery 124 to reduce the main contactor temperature. Otherwise, if the estimated main contactor temperature T is less than the temperature threshold, the system controller 150 keeps the battery 124 at normal operation without taking the mitigation measures.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words processor and processors may be interchanged herein, as may the words controller and controllers.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a battery;
a motor;
a contactor contained in a housing and connected between the battery and motor; and
a controller programmed to, responsive to data indicative of a temperature of the contactor exceeding a threshold, decrease power output from the battery to the motor, wherein the data include parameters indicative of a temperature of the battery, a resistance of an electrical component between the battery and motor, and a thermal resistivity of one or more components other than the battery and motor in a vicinity of the contactor.

2. The vehicle of claim 1, wherein the electrical component is an electrical cable.

3. The vehicle of claim 1, wherein the one or more components include the housing.

4. The vehicle of claim 1, wherein the data further include a parameter indicative of a current passing through the contactor.

5. The vehicle of claim 1, wherein the data further include a parameter indicative of a resistance of the contactor.

6. The vehicle of claim 5, wherein the data further include a product of the thermal resistivity and resistance.

7. The vehicle of claim 1, wherein the data further include one or more parameters indicative of coefficients of thermal decay.

8. A power system comprising:
a controller programmed to execute instructions implementing a thermal model that produces output indicative of a temperature of a contactor connecting a battery and motor based on input indicative of a thermal resistivity of one or more components other than the battery and motor in a vicinity of the contactor, and to decrease power output from the battery to the motor responsive to the temperature exceeding a threshold.

9. The power system of claim 8, wherein the one or more components include a housing for the contactor.

10. The power system of claim 8, wherein the thermal model further produces the output based on input indicative of a current passing through the contactor.

11. The power system of claim 8, wherein the thermal model further produces the output based on input indicative of a resistance of the contactor.

12. The power system of claim 11, wherein the thermal model further produces the output based on input indicative of a product of the thermal resistivity and resistance.

13. A method comprising:
decreasing power output from a battery to a motor after data indicates a temperature of a contactor electrically connecting the battery and motor exceeds a threshold, wherein the data include parameters indicative of a temperature of the battery, a resistance of an electrical component between the battery and motor, and a thermal resistivity of a housing of the contactor.

14. The method of claim 13, wherein the electrical component is an electrical cable.

15. The method of claim 13, wherein the data further include a parameter indicative of a current passing through the contactor.

16. The method of claim 13, wherein the data further include a parameter indicative of a resistance of the contactor.

17. The method of claim 16, wherein the data further include a product of the resistance and thermal resistivity.

18. The method of claim 13, wherein the data further include one or more parameters indicative of coefficients of thermal decay.
